(19) United States
(12) Patent Application Publication
(10) Pub. No.: US 2016/0228762 A1
(43) Pub. Date: Aug. 11, 2016

(54) SYSTEM AND METHOD FOR CREATING GAMIFICATION FRAMEWORK

(71) Applicant: Infosys Limited, Bangalore (IN)

(72) Inventors: Allahbaksh Mohammedali Asadullah, Hubli (IN); Nikita Jain, Banswara (IN); Srinivas Padmanabhuni, Bangalore (IN); Basavaraju Mudu, Bangalore (IN)

(21) Appl. No.: 14/972,714

(22) Filed: Dec. 17, 2015

(30) Foreign Application Priority Data
Dec. 18, 2014 (IN) 6376/CHE/2014

(51) Int. Cl. A63F 9/18; A63F 13/35

(52) U.S. Cl. CPC A63F 9/183; A63F 13/35

(57) ABSTRACT

A method and a system for creating a gamification framework is disclosed. The method includes selecting at least one event from a game. One or more handlers associated with the at least one event of the game is identified. The identified handlers are mapped with one or more user actions associated with a quiz based on a set of rules. The mapped handlers are bound with the quiz to cause gamification of the quiz. The set of rules define one or more execution conditions of the handlers in response to the user actions. An output of the method and/or the system is the gamification of the quiz.

This application claims priority to India Patent Application No. 6376/CHE/2014, filed Dec. 18, 2014, the disclosure of which is hereby incorporated by reference in its entirety.

### FIELD OF TECHNOLOGY

The present disclosure relates generally to a field of gamification and in particular, to a system, method and/or apparatus to create a gaming framework in association with quiz.

### BACKGROUND

Gamification may be defined as using game elements in a non-gaming context to improve user motivation and experience. Studies have shown that gamification can have vast benefits. Adding game elements can simulate primitive, competitive and collaborative instincts that are normally active in people.

Gamifying a quiz requires knowledge of various game elements and mechanics. In an enterprise context, gamification may increase employee participation in quizzes. Enterprises may have certain rules, regulations and policies for employees. The enterprise may occasionally modify the policies. The enterprise may choose to conduct quizzes to measure employee awareness on the policies and the rules. Quiz participants may feel easy to answer question if pattern of the quiz is interesting and different from usual quiz. Gamification of quiz may increase user participation. In present, gamification is also being used widely in non-enterprise environments such as education and marketing. Hence, a system to ease the process of creating a gamification framework is required.

### SUMMARY

Disclosed are a method, an apparatus and/or a system for creating a gamification framework.

In one aspect, a computer implemented method involves selecting one or more events from a game. One or more handlers associated with the one or more events of the game are identified. The one or more events of the game may comprise complexity, level, speed and/or obstacle of the game. The one or more handlers are mapped with one or more user actions associated with a quiz, based on a set of rules. The one or more mapped handlers are bound with the quiz to cause gamification of the quiz. The set of rules may define execution condition of the one or more handlers in response to the one or more user actions.

In another aspect, a system for creating a gamification framework is disclosed. The system includes a memory coupled to one or more processors which are configured to execute programmed instructions stored in the memory to select one or more events from a game, identify one or more handlers associated with the one or more events of the game, map the one or more handlers with one or more user actions associated with a quiz based on a set of rules, and bind the one or more mapped handlers with the quiz to cause gamification of the quiz.

In an additional embodiment, a non-transitory computer readable storage medium creating a gamification framework is disclosed. The computer readable storage medium stores computer executable instructions to select one or more events from a game, identify one or more handlers associated with the one or more events of the game, map the one or more handlers with one or more user actions associated with a quiz based on a set of rules, and bind the one or more mapped handlers with the quiz to cause gamification of the quiz.

The methods and the systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE FIGURES

Example embodiments are illustrated by way of example and not limitation in the figures of the accompanying drawings, in which like references indicate similar elements and in which:

FIG. 1 is a diagrammatic representation of a data processing system capable of processing a set of instructions to perform any one or more of the methodologies herein, according to one embodiment.

FIG. 2 is a process flow diagram, illustrating a method for creating a gamification framework, according to one or more embodiments.

FIG. 3 is a block diagram, illustrating a system for creating a gamification framework, according to one or more embodiments.

FIG. 4 is an architecture diagram, illustrating a system for creating a gamification framework, according to one or more embodiments.

Other features of the present embodiments will be apparent from the accompanying drawings and from the detailed description that follows.

### DETAILED DESCRIPTION

Example embodiments, as described below, may be used to provide a method, an apparatus and/or a system for creating a gamification framework. Although the present embodiments have been described with reference to specific example embodiments, it will be evident that various modifications and changes may be made to these embodiments without departing from the broader spirit and scope of the various embodiments.

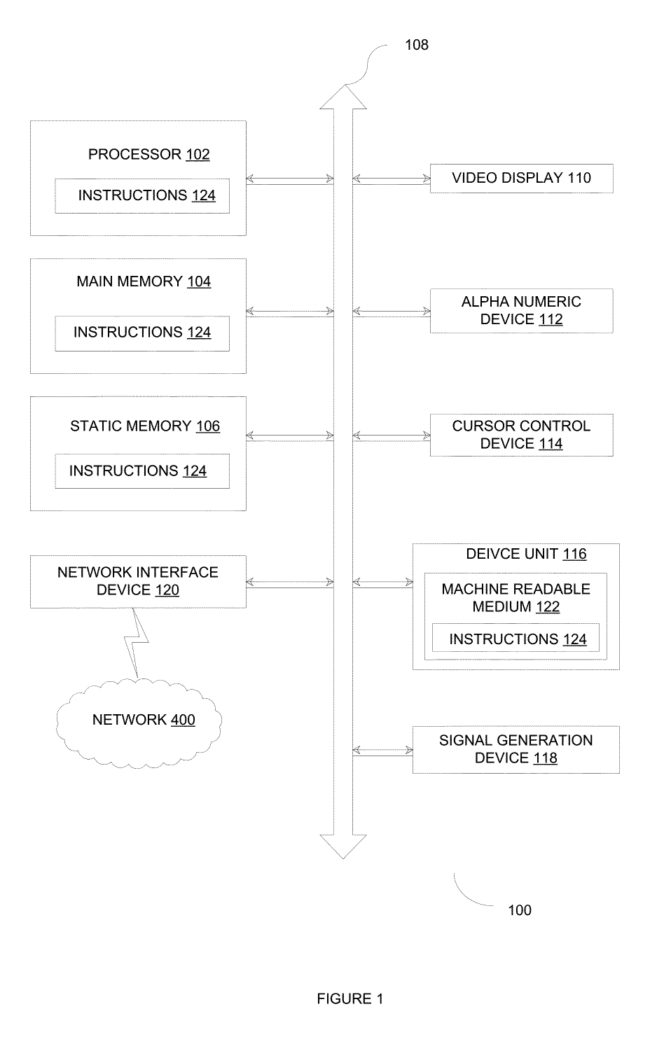

FIG. 1 is a diagrammatic representation of a data processing system capable of processing a set of instructions to perform any one or more of the methodologies herein, according to one embodiment. FIG. 1 shows a diagrammatic representation of machine in the example form of a computer system 100 within which a set of instructions, for causing the machine to perform any one or more of the methodologies discussed herein, may be executed. In various embodiments, the machine operates as a standalone device and/or may be connected (e.g., networked) to other machines.

In a networked deployment, the machine may operate in the capacity of a server and/or a client machine in server-client network environment, and/or as a peer machine in a peer-to-peer (or distributed) network environment. The machine may be a personal-computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 100 includes a processor 102 (e.g., a central processing unit (CPU) a graphics processing unit (GPU) and/or both), a main memory 104 and a static memory 106, which communicate with each other via a bus 108. The computer system 100 may further include a video display unit 110 (e.g., a liquid crystal displays (LCD) and/or a cathode ray tube (CRT)). The computer system 100 also includes an alphanumeric input device 112 (e.g., a keyboard), a cursor control device 114 (e.g., a mouse), a disk drive unit 116, a signal generation device 118 (e.g., a speaker) and a network interface device 120.

The disk drive unit 116 includes a machine-readable medium 122 on which is stored one or more sets of instructions 124 (e.g., software) embodying any one or more of the methodologies and/or functions described herein. The instructions 124 may also reside, completely and/or at least partially, within the main memory 104 and/or within the processor 102 during execution thereof by the computer system 100, the main memory 104 and the processor 102 also constituting machine-readable media.

The instructions 124 may further be transmitted and/or received over a network 400 via the network interface device 120. While the machine-readable medium 122 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

Exemplary embodiment of the present invention provide a system, a method and/or an apparatus for creating a gamification framework for a quiz. The system, the method and/or the apparatus for creating a gamification framework for a quiz, involves selecting one or more events from a game. One or more handlers associated with the one or more events of the game are identified. The one or more events of the game may comprise complexity, level, speed and/or obstacle of the game. The one or more handlers are mapped with one or more actions or response of the user in the quiz, based on a set of rules. The one or more mapped handlers are bound with the quiz to cause gamification of the quiz. The set of rules may define execution condition of the one or more handlers in response to the one or more user actions.

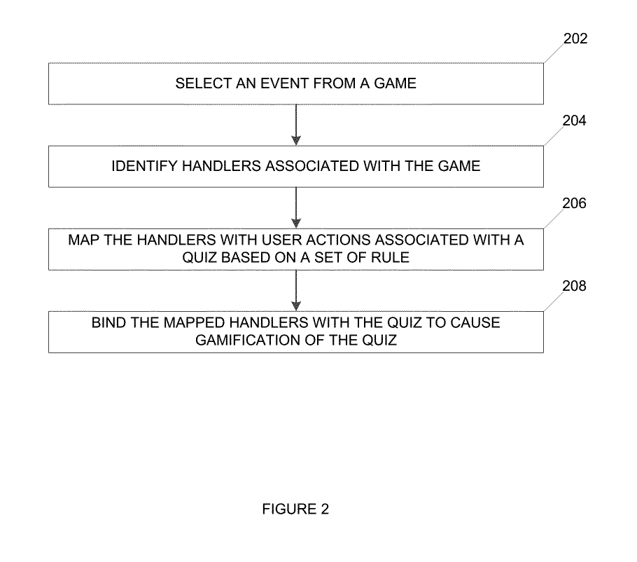

FIG. 2 is a process flow diagram, illustrating a method for creating a gamification framework for a quiz, according to one or more embodiments. The method involves selecting one or more events from a game, as in step 202. Examples of the game may include, but are not limited to stick man, and/or snakes and ladders. One or more handlers associated with the selected one or more events of the game are identified, as in step 204. The game comprises of configurable events. The number of events depend on the game selected. Examples of the event may include, but are not limited to complexity, level, speed and/or obstacle of the game. The one or more identified handlers are mapped with one or more user actions associated with the quiz, based on a set of rules, as in step 206.

The quiz comprises questions and answers. The questions may be a textual content and/or a multi-media content. The set of rules defines one or more execution conditions of the identified one or more handlers in response to the one or more user actions during the quiz. The one or more user actions may include response of a user to the questions of the quiz. The mapped one or more handlers are bound with the quiz to cause gamification of the quiz, as in step 208. The binding in the step 208, may be performed through a differed binding and/or a dynamic binding.

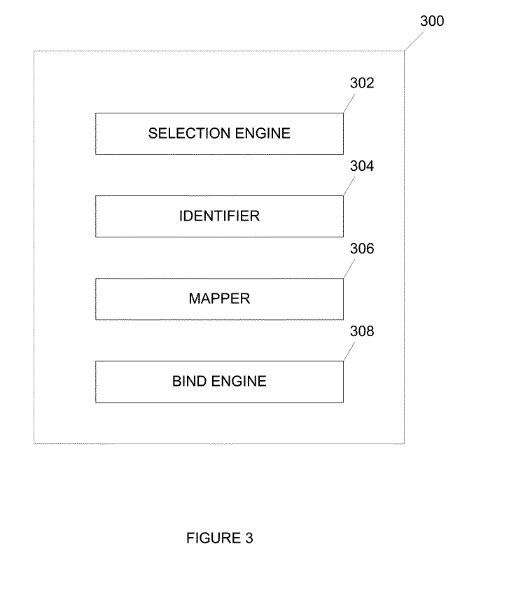

FIG. 3 is a block diagram, illustrating a system for creating a gamification framework for a quiz, according to one or more embodiments. The system involves a selection engine 302, an identifier 304, a mapper 306 and a bind engine 308. All these components (302, 304, 306 and 308) are stored in a memory. The selection engine 302 is configured to select one or more events from a game. Examples of the game may include, but are not limited to stick man, and/or snakes and ladders. The identifier 304 is configured to identify one or more handlers associated with the one or more events of the game. The game comprises configurable events. The number of events depend on the game selected. Examples of event may include, but are not limited to complexity, level, speed and/or obstacle of the game. The mapper 306 is configured to map the identified one or more handlers with one or more user actions associated with the quiz, based on a set of rules.

The quiz comprises questions and answers. The questions may be a textual content and/or a multi-media content. The set of rules defines one or more execution conditions of the identified one or more handlers in response to the one or more user actions. The one or more user actions may be a response of a user to the questions of the quiz. The bind engine 308 is configured to bind the mapped one or more handlers with the quiz to cause gamification of the quiz. The bind engine 308 may perform the binding through a differed binding and/or dynamic binding.

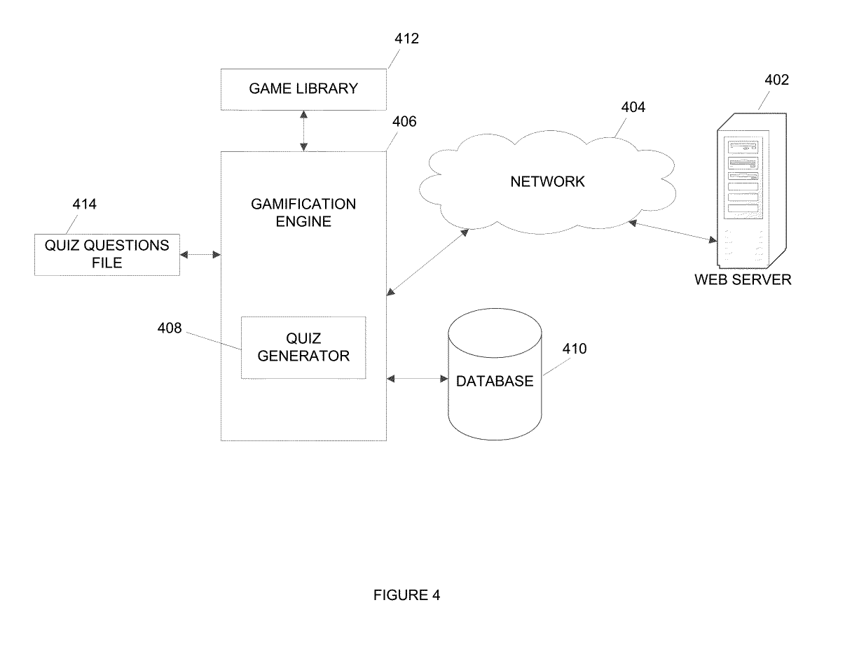

FIG. 4 is an architecture diagram, illustrating computing environment for creating a gamification framework, according to one or more embodiments. In the present embodiment, the computing environment comprises a web server 402, a network 404, a gamification engine 406, a quiz generator 408, a database 410, a game library 412, and quiz questions 414. The gamification engine 406 is communicatively coupled with web server 402, through the network 404. The gamification engine 406 is configured to provide administration and configuration facilities to create the gamification framework. The quiz questions file 414 is configured to provide questions and answers of a quiz as input to the gamification engine 406. In another embodiment, the questions and the answers may be provided to the gamification engine through, but not limited to REpresentational State Transfer (REST) based interface and/or Simple Object Access Protocol (SOAP) based web services.

The database 410 is configured to store the questions and the answers of the quiz. The database 410 is further configured to store one or more responses of the quiz. A schema of the database 410 may handle a textual and/or a multimedia questions. The game library 412 is configured to store one or more games. The gamification engine 406 is configured to fetch the one or more games from the game library 412. The stored one or more games may be developed based on one or more libraries but not limited to PlayN library, Apache Cordava, and Xamrin. The one or more games may be pluggable games.

The pluggable games, developed based on the one or more libraries may expose one or more interfaces for modification. The one or more interfaces are converted into unified input events. In the unified input events, the one or more interfaces may call events. The events may call one or more library events, declared in the game library 412. A user may inherit the one or more interfaces to create a gamification framework.

The quiz generator 408 is configured to receive the questions and the answers from the quiz questions file 414, through the gamification engine 406. The quiz generator 408 is further configured to receive the one or more games from the game library 412, through the gamification engine 406. The quiz generator 408 generates a gamified quiz. The gamified quiz may be of, but not limited to apk, HTML (Hyper-Text Markup Language), and/or jar format. In another embodiment, the quiz generator 406 generates REST URL (Uniform Resource Locator) of the gamified quiz.

The method of present disclosure can be illustrated based on below example. This example is provided only for the understanding purpose and not to limit the scope of the disclosure. The example can be illustrated based on a snakes and ladders game. An event of the snakes and ladders may be movement of a token from one block to another block of a game board. One or more handlers associated with the event is identified. The one or more identified handlers may be, but are not limited to ISuccessCallBack, IFailureCallBack, INextMoveCallBack, ILevel, and/or IScoreUpdate. A handler may be a program, designed to perform specific actions. A success handler may be a program, which is executed as per the game signature defined by a developer.

These handlers are mapped to actions of a user in a quiz, which is to be gamified. Selection of next question in the quiz, by a user, can be considered as a user action. If the user moves to the next question then there may be two possibilities. The two possibilities may be correctness and incorrectness of an answer. If the answer is correct, the user action may be mapped to the success handler. If the answer is wrong, the user action may be mapped to a failure handler. The set of rules may comprise score change criteria, level change criteria and control of movements in the game. The mapped one or more handlers are bound to the quiz. The result of the mapping may be a gamified quiz. If a user selects correct answer, result of the correct answer may be reflected in the snakes and ladders game based on the one or more mapped handlers.

On answering the quiz questions correctly, the token in the snakes and ladders game moves forward. On answering the quiz questions wrongly, the token in the snakes and ladders game moves backward. On both the forward and backward movement, game rules such as snake bite and ladder climbing are handled through the one or more handlers.

A user interface facilitates a user in mapping handlers with event of a game. The framework can be validated to check the association of handlers and events.

Advantage of disclosed method, system and/or apparatus for creating a gaming framework is as described here in. The method, the system and/or the apparatus reduces time required in gamifying a quiz.

The present embodiment, the method, the system and/or apparatus support interaction with one user. In another embodiment, the method, the system and/or apparatus support interaction with more than one user.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer devices), and may be performed in any order (e.g., including using means for achieving the various operations). Various operations discussed above may be tangibly embodied on a medium readable through the retail portal to perform functions through operations on input and generation of output. These input and output operations may be performed by a processor. The medium readable through the retail portal may be, for example, a memory, a transportable medium such as a CD, a DVD, a Blu-ray™ disc, a floppy disk, or a diskette. A computer program embodying the aspects of the exemplary embodiments may be loaded onto the retail portal. The computer program is not limited to specific embodiments discussed above, and may, for example, be implemented in an operating system, an application program, a foreground or background process, a driver, a network stack or any combination thereof. The computer program may be executed on a single computer processor or multiple computer processors.

Accordingly, the specification and drawings are to be regarded in an illustrative rather than a restrictive sense.

1. A computer implemented method for associating at least one quiz with a gaming system, comprising:
receiving, over a computer network, a request to associate the at least one quiz with at least one game;
choosing, over the computer network, the game from a game library based on the request;
loading, through the processor over a computer network, the game onto the gaming system;
identifying, on the gaming system over the computer network, one or more events associated with the game;
identifying, through a processor, one or more handlers associated with the one or more events;
mapping, through a processor, the one or more handlers with one or more user actions based on a set of rules,
wherein the one or more user actions are associated with the at least one quiz,
wherein the one or more user actions are received at a user terminal communicatively coupled to the computer network; and
binding, through a processor, the one or more mapped handlers with the at least one quiz to associate the at least one quiz with the gaming system.

2. The method of claim 1, wherein the set of rules define execution conditions of the one or more handlers in response to the one or more user actions.

3. The method of claim 1, wherein the at least one event of the game comprises at least one of a complexity, level, speed, and obstacle of the game.

4. The method of claim 1, wherein the one or more user actions comprise response of the user to a quiz question.

5. The method of claim 1, wherein the binding is performed through deferred binding.

6. A gaming system in association with a plurality of quizzes, comprising:
one or more processors;
a computer network;
a game library;
a web server; and
one or more memory units operatively coupled to at least one of the one or more processors and having instructions stored thereon that, when executed by at least one of the one or more processors, cause at least one of the one or more processors to:
receive, over the computer network, a request to associate the at least one quiz with at least one game;
choose, over the computer network, the game from a game library based on the request;
load, through a processor over the computer network, the game onto the gaming system;
identify, on the gaming system over the computer network, one or more events associated with the game;
identify, through a processor, one or more handlers associated with the one or more events;
map, through a processor, the one or more handlers with one or more user actions based on a set of rules,
wherein the one or more user actions are associated with the at least one quiz,
wherein the one or more user actions are received at a user terminal communicatively coupled to the computer network; and
bind, through a processor, the one or more mapped handlers with the at least one quiz to associate the at least one quiz with the gaming system.

7. The system of claim 6, wherein the set of rules define execution conditions of the one or more handlers in response to the one or more user actions.

8. The system of claim 6, wherein the at least one event of the game comprises at least one of complexity, level, speed, and obstacle of the game.

9. The system of claim 6, wherein the user actions comprise response of the user to a quiz question.

10. The system of claim 6, wherein the binding is performed using deferred binding.

11. A gamification device associated with a game library, storing computer-readable instructions that, when executed by one or more computing devices, cause at least one of the one or more computing devices to:
receive, over the computer network, a request to associate the at least one quiz with at least one game;
choose, over the computer network, the game from a game library based on the request;
load, through a processor over the computer network, the game onto the gaming system;
identify, on the gaming system over the computer network, one or more events associated with the game;
identify, through a processor, one or more handlers associated with the one or more events;
map, through a processor, the one or more handlers with one or more user actions based on a set of rules,
wherein the one or more user actions are associated with the at least one quiz,
wherein the one or more user actions are received at a user terminal communicatively coupled to the computer network; and
bind, through a processor, the one or more mapped handlers with the at least one quiz to associate the at least one quiz with the gaming system.

12. The gamification device of claim 11, wherein the set of rules define execution conditions of the one or more handlers in response to the one or more user actions.

13. The gamification device of claim 11, wherein the at least one event of the game comprises complexity, level, speed, or obstacle of the game.

14. The gamification device of claim 11, wherein the user actions comprise response of the user to a quiz question.

15. The gamification device of claim 11, wherein the binding is performed using deferred binding.
